(19) United States
(12) Patent Application Publication
(10) Pub. No.: US 2007/0178841 A1
(43) Pub. Date: Aug. 2, 2007

(54) Apparatus and methods for concurrent wireless network analysis

(75) Inventors: Roman T. Oliynyk, Minnetonka, MN (US); Dwight Benson, Eden Prairie, MN (US); Douglas M. Smith, Mound, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Network Instruments, LLC

(21) Appl. No.: 11/341,295

(22) Filed: Jan. 27, 2006

(51) Int. Cl. H04B 17/00

(52) U.S. Cl. 455/67.11; 455/115.1; 455/226.1

(57) ABSTRACT

Methods and apparatus for simultaneous wireless network analysis are described. The apparatus may include a plurality of wireless receivers and a discriminator/analyzer module to identify data items being transmitted over one or more communications channels received by the plurality of wireless receivers. The method may comprise receiving a plurality of wireless communications signals, identifying unique communications channels and discriminating between the unique communications channels and separating the signals into unique communications streams. The method may additionally include analyzing the unique communications streams.

### TECHNICAL FIELD

This application relates to apparatus and methods for network management and more particularly to concurrent wireless network analysis.

### BACKGROUND

Wireless computer networks are being used to provide inexpensive high-speed network connections to individuals, businesses and communities. The costs associated with wired networks have become prohibitive. The proliferation of easy to use and inexpensive wireless routers has resulted in an explosion of deployments.

Unfortunately, this ease of deployment has created many problems for network designers. Some of these problems include interference between wireless routers and wireless clients when the deployment of those wireless routers does not take into account other wireless routers that may be operating nearby. Other problems exist for wireless clients connecting to wireless routers and networks they did not intend to. These two problems are unintentional. Yet other problems exist where rogue routers are deployed intentionally with the objective of infiltrating secured networks or capturing network traffic illegally.

In the wired network space, rogue devices on the network may be quickly identified and dealt with. In the wireless network space, rogue devices and routers present a problem for network administrators that can not be dealt with in the same manner.

### BRIEF DESCRIPTION OF DRAWINGS

Embodiments of the present invention are illustrated by way of example and not limitation in the figures of the accompanying drawings, in which like references indicate similar elements and in which:

FIG. 1 shows a block diagram of a system of wireless devices on a plurality of wireless networks, according to an example embodiment;

FIG. 2A shows is a high level block diagram of an apparatus for analysis of wireless signals, according to an example embodiment;

FIG. 2B shows a more detailed block diagram of an apparatus for analysis of wireless signals, according to an example embodiment;

FIG. 3 shows a block diagram of a system for analysis of wireless signals, according to an example embodiment;

FIG. 4 shows a flowchart of a method of analyzing network data signals transmitted over a wireless network, according to an example embodiment; and

FIG. 5 block diagram of a machine including instructions to perform any one or more of the methodologies described herein.

### DETAILED DESCRIPTION

In the following detailed description of example embodiments, reference is made to the accompanying drawings, which form a part hereof, and in which is shown, by way of illustration, specific embodiments where the example method, apparatus and system may be practiced. It is to be understood that other embodiments may be utilized, and structural changes may be made, without departing from the scope of this description.

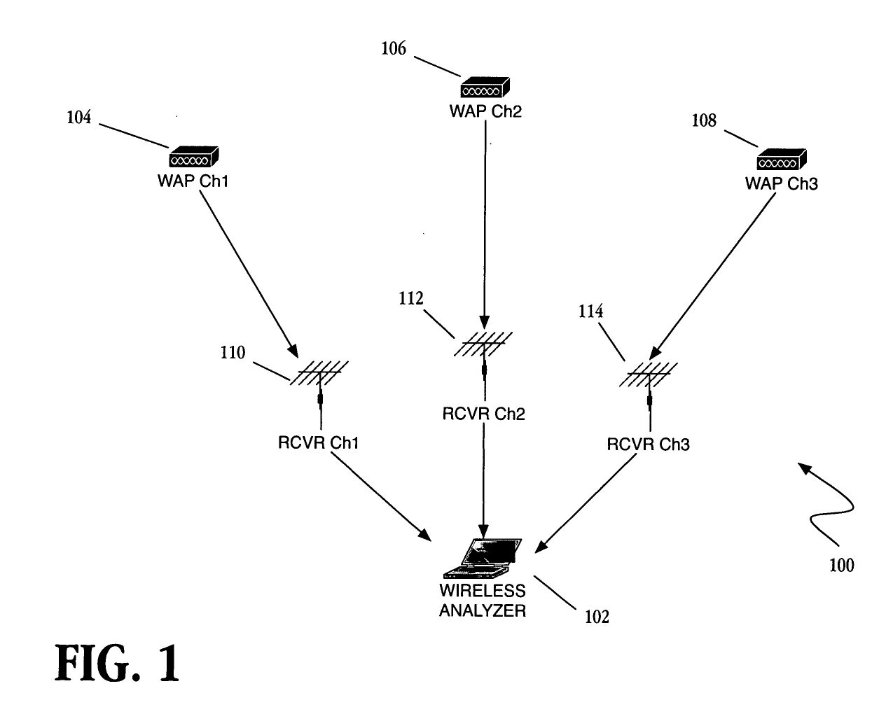

FIG. 1 shows a block diagram of a system of wireless devices on a plurality of wireless networks, according to an example embodiment. The system 100 comprises one or more wireless access points (WAP) and a wireless analyzer 102. The one or more WAPs may include WAPs operating on separate wireless channels or similar wireless channels.

As depicted in FIG. 1 the one or more WAPS may include a WAP on channel 1, WAP Ch1 104, a WAP on channel 2, WAP Ch2 106 and a WAP on channel 3, WAP Ch3 108. A channel as used herein is a specific radio frequency or band of frequencies, usually in conjunction with a predetermined symbol, allocated by international agreement. For example, 802.11b/g (as defined by IEEE Std. 802.11-1999, published 1999 and later versions (hereinafter 802.11); IEEE Std. 802.11b-1999, published 1999 and later versions (hereinafter IEEE 802.11b); and IEEE Std. 802.11g-2003, published 2003 and later versions (hereinafter 802.11g)) defines 14 possible channels over which a WAP and a client may communicate. The 802.11b/g standard defines each channel by a center channel frequency, and provide for a minimum power loss as the frequency departs from that center channel. In the 802.11b/g standard, the center frequencies of each channel are separated by 5 Mhz, and the signal must be attenuated by a minimum of −30 Db at +/1 11 Mhz from the center frequency. This is also known as the spectral mask

In an embodiment, the WAP is configured to send and receive wireless signals from one or more wireless clients over a single channel. In FIG. 1, for example, WAP Ch1 104 is configured to communicate on channel 1, operating at a center frequency of 2412 Mhz. However, as depicted in FIG. 1, two additional WAPs are operating in close proximity to WAP Ch1 104, WAP Ch2 106 and WAP Ch3 108. In this example, WAP Ch2 106 is configured to communicate on channel 2, operating at a center frequency of 2417 Mhz and WAP Ch3 108 is configured to communicate on channel 3, operating at a center frequency of 2422 Mhz. The spectral mask for 802.11b/g defines that a signal on Ch2 must be attenuated by a minimum of −30 dB at ±11 Mhz from the center channel. The performance of communications between a particular WAP and a wireless client can be determined by a signal-to-interference ratio (S/I or SIR), which is defined as the ratio of a data signal to the interference signal. SIR is typically considered to be more critical to performance then the signal-to-noise (SNR) ratio. The signals generated by equipment operating on a particular channel are by no means perfect and typically generate at least some side band emissions. This is provided for in the spectral mask requirement of 802.11b/g. However, as the noise or interference from wireless devices operating on channels adjacent to a specific channel dominates the noise and interference floor of the specific channel, the smaller the possible SIR on that channel can be. The performance of the devices on that specific channel is thereby degraded.

Adjacent channels include any channels that are near the specific channel as defined in the bandplan applicable to the particular wireless communications protocol being used. Using the 802.11b/g band plan as an example, if the specific channel in question is channel 4, the adjacent channels may include channels 2, 3, 5 and 6. It may additionally include other channels outside those, as there may be some interference experienced on channel 4 due to their communications. This adjacent channel interference (ACI) creates wireless network design challenges for the network designer. Typically, a network designer having total control over a physical area places a minimal number of WAPs in close proximity to each other to provide optimal network performance. These WAPs operate with as much channel separation as possible. For 802.11b/g network designs, three WAPs operating on three distinct channels in close proximity to each other provide the greatest network performance over those three channels (typically 1, 6, and 11). Addition of a fourth WAP in an 802.11b/g network may provide additional network performance with little degradation in performance due to ACI, though network performance in such an arrangement is less than that of the previous example.

However, with the advent of inexpensive WAPs freely available that require little to no configuration by an end-user, the network designer faces greater challenges then ever before. These include employees placing rogue WAPs (unauthorized) on the corporate network, companies in close physical proximity operating their own WAPs without regard to currently operating WAPs, illegal actors operating WAPs in close proximity intended to hijack communications, as well as many other challenges not listed here. The network designer and network operators need to have some method by which they can detect these WAPs, as well as monitor the network performance of their own WAPs. One of the ways of optimizing network performance and detecting unauthorized or interfering WAPs is through analysis of traffic of data items over the network. The methods of network analysis or packet capture on a wired network are well known and typically include placing a network-capable device on a network, configuring the network interface device to operate in a promiscuous mode (capturing all network traffic on the accessible network without regard to the addresses in the packet headers) and then analyzing that network traffic. In the wireless context, network analysis of signals transmitted over a single channel is complicated by the possibility that multiple channels may be operating in close physical proximity to each other.

A more comprehensive network analysis of a particular band of wireless signals, such as 802.11b/g, requires that the wireless analyzer 102 listen to communications signals on all channels. In one embodiment, this may include stepping through the available channels in sequence. In such an example, the wireless analyzer 102 would receive signals on channel 1 for a specified period of time, reconfigure and receive signals on channel 2 for a specified period of time, reconfigured and receive signals on channel 3 for a specified period of time, etc. However, this type of stepping through the spectrum, though useful for generating a survey of communications occurring in that area, does not capture all the network traffic in the area in that spectrum.

In an embodiment, the wireless analyzer 102 is configured to include more than one receiver, each of them configured to receive wireless signals on a particular channel in the spectrum being analyzed. In such an example, and using 802.11b/g as an illustration, the wireless analyzer 102 would include 14 receivers, each configured to receive signals on a distinct channel. It will be understood that though 14 channels are provided for in the 802.11b/g standard, usage of those channels is regulated by differing country's laws so that in a particular country, the number of channels authorized for usage, and therefore the number of receivers in the wireless analyzer 102, may be some number less then 14. The wireless analyzer 102 may also include a transceiver configured to send and receive wireless signals on any of the available channels.

Usage of the wireless analyzer 102 provides the network analyst or designer the ability to detect wireless devices in a particular area. Through this mechanism, the network analyst can determine if rogue WAPs or wireless devices are operating on their network. The network designer can determine which channels they may be able to use, given the current usage of the wireless spectrum in that area. Additionally, the network analyst can capture the network traffic being generated by the wireless devices. This may be useful in generating a baseline of network traffic. The baseline can be used in the future to identify traffic that may be unauthorized. The network traffic captured can also be used as forensic evidence in criminal cases where the rogue wireless device is illegally utilizing network resources. Such illegal usage is sometimes called war-driving, and carries with it various civil and criminal penalties.

Though mention will be made herein to the channels prescribed in 802.11, the systems and methods described here have equal applicability to any wireless protocol, including, without limitation, a wireless protocol that divides a frequency spectrum into a series of separate and overlapping channels. For instance, with respect to the 802.11b protocol, the frequency spectrum from 2.412 hz to 2.484 Khz is divided into 14 channels. Each channel is numbered in sequence beginning with channel 1 and ending with channel 14. Each of the channels can be defined by a frequency on which the power of the signal transmitted over it is the greatest, otherwise known as the center channel frequency and a spectral mask. The spectral mask defines the amount that a signal must be attenuated from peak energy at a specific frequency separation from the center frequency. Referring specifically to 802.11, the center frequency for channel 1 is 2412 Mhz and the signal must be attenuated by at least 30 dB from a peak at ±11 Mhz from 2412 Mhz. The spectral mask allows for more than one WAP to operate in physical proximity to each other without undue interference.

The network designer of an 802.11b network has multiple channels to use when setting up an 802.11 network. In the United States, 11 of the 14 defined channels may be used, though other channels may be able to be used in other regions of the world. However, placing two WAPs, one on channel 1 and the other on channel 2, results in a signal transmitted over channel 1 interfering with signals sent transmitted over channel 2. The experienced network designer typically utilizes no more than 4 channels placed in proximity of each other. This limits the interference that one channel experiences from another channel to acceptable levels. Configuring two WAPs to operate on adjacent channels and placing them in proximity to each other causes too much interference and may in some cases cause security concerns.

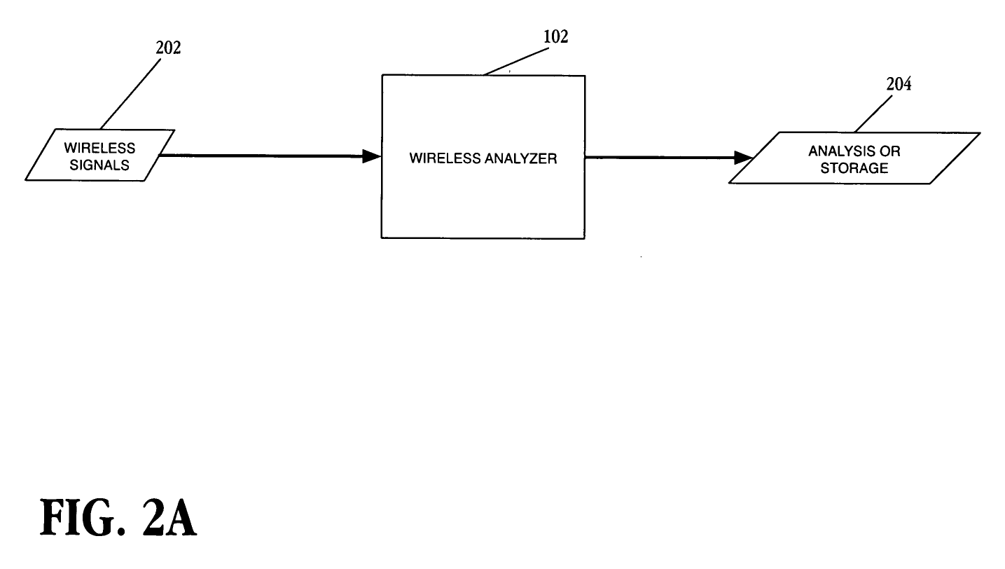

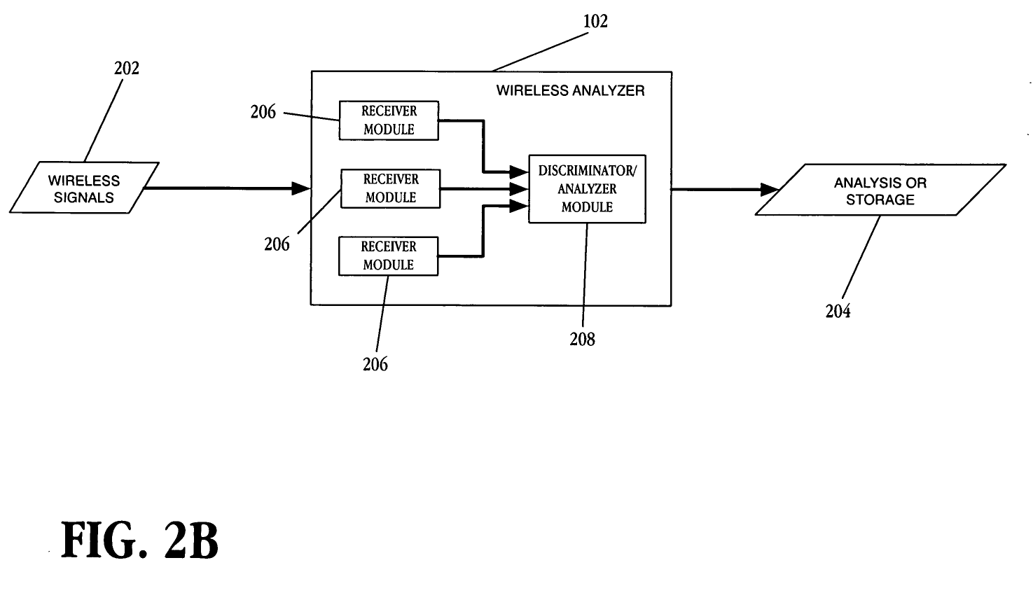

FIG. 2A shows a high level block diagram of an apparatus for analysis of wireless signals, according to an example embodiment. In an embodiment, the apparatus shown in FIG. 2A is a wireless analyzer 102 as described above with respect to FIG. 1. The wireless analyzer 102 is configured to receive a plurality of wireless signals 202 and provide an analysis of the wireless signals 204, in one example. In another example, the wireless analyzer 102 provides an analysis, stores data items or both provides an analysis and stores data items. In a further embodiment, the wireless analyzer 102 provides an analysis of the wireless signals and is additionally configured to store the plurality of wireless signals 202.

In an embodiment, the wireless analyzer 102 is configured to receive wireless signals sent over one or more communications channels concurrently, identifying data items send over each of the one or more communications channels and perform network analysis on the data items. In one embodiment, the wireless analyzer 102 captures wireless signals sent using a specific protocol, such as 802.11b/g. In such an example, up to 14 channels could be used. The wireless analyzer 102 may capture all 14 channels of wireless signals concurrently. As discussed above, this provides a mechanism by which all wireless signals being transmitted can be captured and analyzed.

Using the system described above in FIG. 1 as an example for the purposes of illustration, the functions of the wireless analyzer 102 can be described further. In the example, the wireless analyzer 102 is coupled to three receivers, RCVR Ch1 110, RCVR Ch2 112, and RCVR Ch3 114. Each of the receivers is configured to receive wireless signals on one channel in the 802.11b/g band plan. As discussed above, the center channel frequencies of the channels are 2412 Mhz, 2417 Mhz and 2422 Mhz, respectively. Because the spectral mask defined in 802.11b/g does not require a great enough attenuation at ±5 Mhz (center channel frequency separation), the signal from channel 2 causes interference and increases the noise floor for both channels 1 and 3. This has the effect of decreasing the SIR and the network performance for wireless device operating on channels 1 and 3. Conversely, the signals on channels 1 and 3 are interference to channel 2 and decreases network performance of channel 2.

In an embodiment, the wireless analyzer 102 receives the wireless signals from the receivers. The wireless analyzer 102 may identify the network signals being transmitted on each of the three communications channels. Separating the wireless signals into discrete communications channels can be performed using any suitable method and is discussed in further detail below. The wireless analyzer 102, using the separated wireless signals, could further capture those signals and perform analysis on those captured signals.

FIG. 2B shows a more detailed block diagram of an apparatus for analysis of wireless signals, according to an example embodiment. In an embodiment, the wireless analyzer 102 comprises one or more receiver modules 206 and a discriminator/analyzer module 208.

In an embodiment, each of the one or more receiver modules 206 is configured to receive wireless signals on a single wireless communications channel. The one or more receiver modules 206 may include, without limitation, a radio configurable by software, a radio configurable by firmware, or a hard-configured electronic circuit configured to receive signals on a specific frequency. The receiver module may additionally be coupled to an RF to IF converter and an A/D converter, the A/D converter to convert the analog wireless signals received by the receiver (raw signals) into digital signals operable on by the discriminator/analyzer module 208 (processed signals).

In an embodiment, the discriminator/analyzer module 208 is configured to receive the processed signals from the one or more receiver modules 206 and perform analysis operations on those signals. This may include, but not be limited to, receiving the processed signals from each of the one or more receiver modules 206, storing the processed signals, and analyzing the network signals. The discriminator/analyzer module 208 may be a Field Programmable Gate Array (FPGA) or an Application Specific Integrated Circuit (ASIC). In an embodiment, the discriminator/analyzer module 208 is configured to down convert the signal and apply any suitable digital signal processing (DSP) algorithms to recover the data item contained within the signal.

In one embodiment, the functions of the discriminator/analyzer module 208 are performed by a Xilinx Virtix 4 FX12 FPGA. In one example, it includes a 10/100/1000 ethernet interface, a 405 PowerPC processor and dedicated DSP circuitry. In some examples, a 12 bit 85+ MHz A/D is used for digitizing the in-phase (I) and quadrature (Q) outputs from the RF to IF converter section. Any suitable software instructions contained on the discriminator/analyzer module 208 or on a storage device accessible to the discriminator/analyzer module 208 can be used to perform the demodulation and recovery of the digital data stream. The discriminator/analyzer module 208 may be further configured to format the results of the network analysis in to a format usable only for communications to a Network Instruments Observer computing device, in one example. The results may be transmitted to the Network Instruments Observer over an external interface or stored on a storage device accessible to the discriminator/analyzer module 208 and retrieved later.

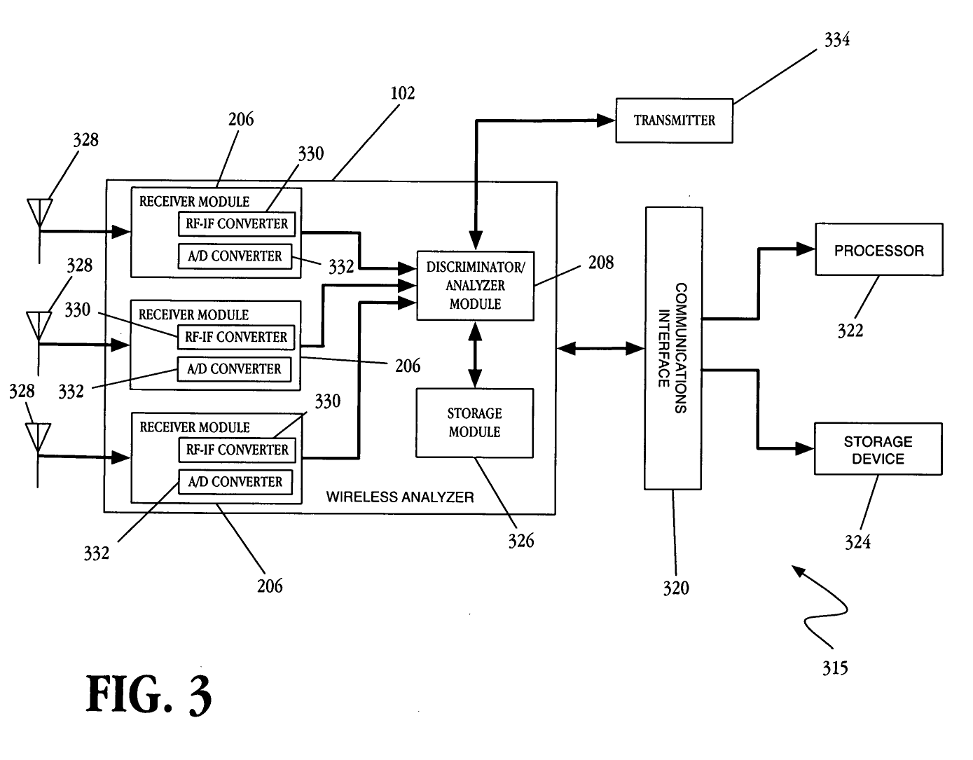

FIG. 3 shows a block diagram of a system for analysis of wireless signals, according to an example embodiment. The system includes a wireless analyzer 102 and a communications interface 320. In a further embodiment, the system additionally includes a processor and a storage device 324 coupled to the communications interface 320. The wireless analyzer 102 includes a discriminator/analyzer module 208 and one or more receiver modules 206. The discriminator/analyzer module 208 is coupled to a storage module 326, in some examples. The one or more receiver modules 206 are each coupled to an antenna 328 and include an RF/IF converter 330 and an A/D converter 332, in some examples. In one embodiment, the discriminator/analyzer module 208 is coupled to a transmitter 334.

In one embodiment, the wireless analyzer 102 is a stand-alone device which may be placed in any suitable location to capture network signals and perform analysis on those signals. In such an example, the wireless analyzer 102 would at some time after being placed be connected through any suitable means to a network or computing device to transfer the captured signals and analysis to another device.

In another embodiment, the wireless analyzer 102 is a device that can be connected through any suitable communications bus to a computing device. In such an example, the wireless analyzer 102 may be configured to just capture the network signals and pass the signals to the computing device for analysis. Additionally, the wireless analyzer 102 may perform preliminary analysis on the network signals, and transmit the preliminary analysis and the captured signals to the computing device.

In yet another embodiment, the wireless analyzer 102 is a device that can be installed in a computing device, such as on a PCI card or PCMCIA card. In such an example, the wireless analyzer 102 would receive its power over the installation method and be configured to capture the network signals and transmit them to the computing device over a suitable communications bus.

The system depicted in FIG. 3 is one example of a system using an apparatus such as that depicted in FIG. 2A and FIG. 2B. In an embodiment, the wireless analyzer 102 comprises one or more receiver modules 206 and a discriminator/analyzer module 208. The wireless analyzer 102 may additionally include a storage device 324 coupled to the discriminator/analyzer module 208. In some examples, the storage device 324 may be configured to store captured network signals for later analysis or transfer. The storage device 324 may also include machine-readable instructions that when executed cause the discriminator/analyzer module 208 and the one or more receiver modules 206 to perform one or more operations. In the example of the discriminator/analyzer module 208, these instructions may alternately be stored within the discriminator/analyzer module 208. In the example of the one or more receiver modules 206, these instructions may include instructions intended to cause a change in the operations of the one or more receiver modules 206, the change to include, but not be limited to, a re-configuration of the frequency on which the one or more receiver modules 206 receives wireless signals on.

In an embodiment, the storage module 326 coupled to the discriminator/analyzer module 208 includes any suitable electronic storage means. These may include, without limitation, RAM modules, compact flash, secure digital cards, removable flash memory devices, hard drives and the like. The storage module 326 may include machine-readable instructions which when executed cause the discriminator/analyzer module 208 to perform operations described herein. Additionally, the storage module 326 may be configured to store the network traffic captured by the one or more receiver modules 206.

In an embodiment, the wireless analyzer 102 is coupled to the computing device using a suitable communications interface 320. The communications interface 320 may include, without limitation, PCI, PCI-E, USB 2.0, IEEE 1394 (Firewire), or Ethernet. The communications interface 320, in one example, removeably attaches the wireless analyzer 102 to the computing device. In another example, the wireless analyzer 102 is contained within the computing device, such as on a PCI card. In yet another example, the wireless analyzer 102 is configured to capture and store network traffic over a period of time and is unconnected to any computing device during that period of time. In such an example, the wireless analyzer 102 may be subsequently connected to the computing device using the communications interface 320 and is configured to transfer the stored network traffic to the computing device for analysis. In a further embodiment, the wireless analyzer 102 may perform preliminary network analysis on the captured network traffic and is configured to communicate the preliminary network analysis and the stored network traffic to the computing device concurrently.

In an embodiment, the wireless analyzer 102 is coupled to a transmitter 334. In one example, the transmitter 334 is configured to transmit wireless signals on a single frequency. In an alternate example, the transmitter 334 is configured to transmit and receive wireless signals on that single frequency. In such an example, the wireless signals received by the transmitter 334 are wireless signals addressed to the wireless analyzer 102 or to the computing device if the wireless analyzer 102 is presently coupled to the computing device at the time the wireless signal is received by the transmitter 334.

In an embodiment, the one or more receiver modules 206 include an RF/IF Converter 330 and an A/D converter 332. The RF/IF converter 330 is configured to convert the RF signals received by the antenna 328 coupled to the receiver module into an IF signal operable by the A/D converter 332, in one example. The A/D converter 332 is configured to convert the analog radio signals to a digital signal operable by the discriminator/analyzer module 208. In a further embodiment, the one or more receiver modules 206 additionally includes machine-readable instructions which when executed cause a change in the configuration of the one or more receiver modules 206. This may include, without limitation, changing the frequency on which signals are received. In another embodiment, the antenna 328 is contained within the receiver module 206. In an alternate embodiment, the antenna 328 is external to the receiver module 206, but still communicatively coupled to it.

The computing device may comprise a processor 322 and a storage device 324. The storage device 324 includes machine-readable instructions contained therein which when executed cause the processor to perform the operations described herein. The operations may additionally include any suitable method of network analysis not described herein.

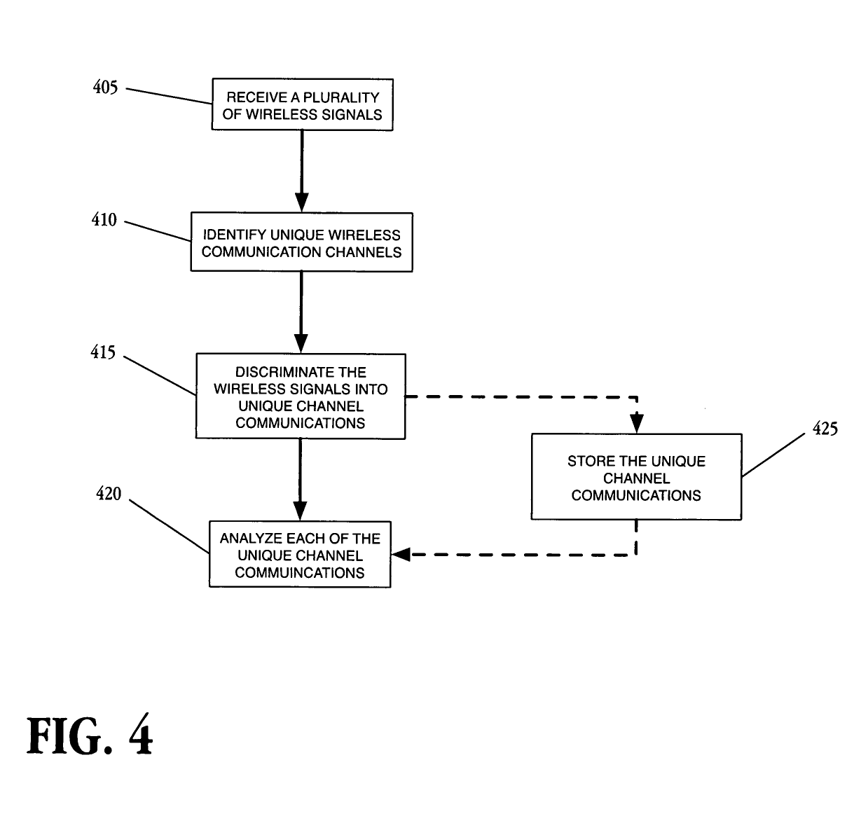

FIG. 4 shows a flowchart of a method of analyzing network data signals transmitted over a wireless network, according to an example embodiment. The operations depicted in FIG. 4 may be performed on the wireless analyzer 102 depicted in FIG. 2A or the system depicted in FIG. 3, in some examples.

At block 405, a plurality of wireless signals 202 are received. In one embodiment, the plurality of wireless signals 202 includes a plurality of wireless signals 202 sent over one or more wireless communications channels and the plurality of wireless signals 202 are received concurrently. In another embodiment, the plurality of wireless signals 202 are received over one or more adjacent wireless communications channels. In yet another embodiment, the plurality of wireless signals 202 includes a plurality of wireless signals 202 received on all wireless communications channels defined in a band plan and allowable by local regulations. For example, with respect to 802.11b/g, only channels 1-11 are allowable in the United States.

At block 410, each of the wireless communications channels being used for wireless communications are identified. In one embodiment, this includes determining which communications channels are being used through dynamic monitoring of the radio frequencies defined by a particular wireless communications protocol. In another embodiment, the communications channels being used are pre-configured.

At block 415, the plurality of wireless signals 202 are discriminated into unique communications sent over each of the identified wireless communications channels. In one embodiment, the signals are discriminated down converting the signals and applying any suitable digital signal processing (DSP) algorithms to recover the data items contained within the signals. In a further embodiment, the operations at block 415 are performed by a discriminator/analyzer module 208 as described above with respect to FIG. 2A and FIG. 2B.

At block 420, the unique channel communications are analyzed using any suitable means or software application, in one example. In one example, the analysis is performed using the Network Instruments Observer application. In an alternate example, the unique channel communications are stored for future analysis at block 425. Alternately, the unique channel communications may be stored at block 425 and analysis of those unique channel communications are performed at block 420.

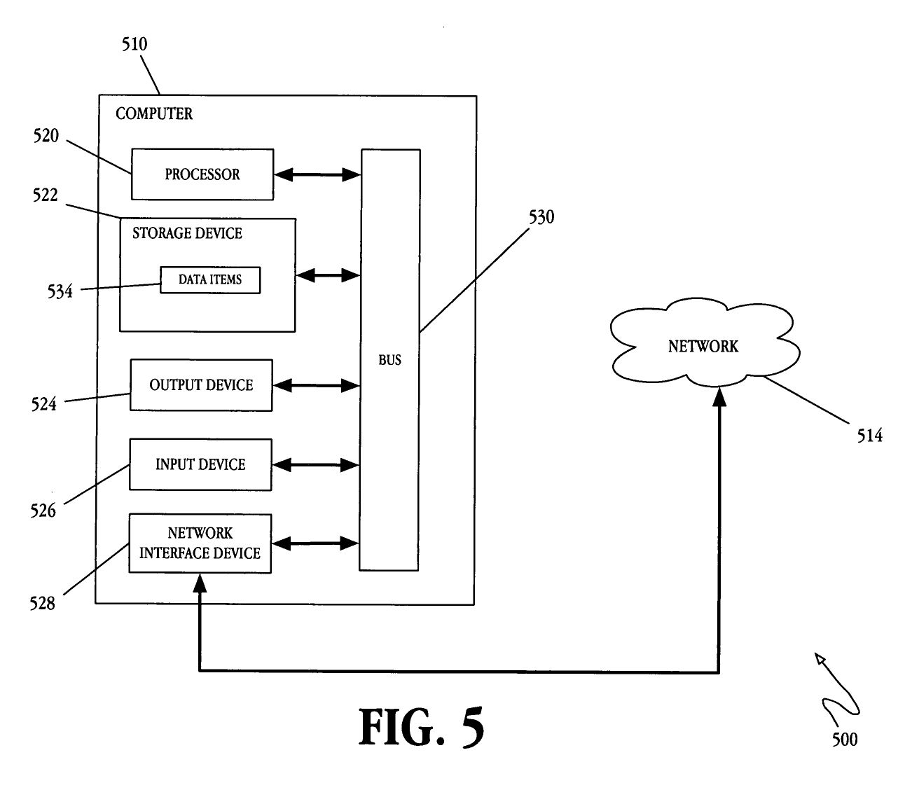

FIG. 5 block diagram of a machine including instructions to perform any one or more of the methodologies described herein. A system 500 includes a computer 510 connected to a network 514. The computer 510 includes a processor 520, a storage device 522, an output device 524, an input device 526, and a network interface device 528, all connected via a bus 530. The processor 520 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor 520 executes instructions and includes that portion of the computer 510 that controls the operation of the entire computer. Although not depicted in FIG. 5, the processor 520 typically includes a control unit that organizes data and program storage in memory and transfers data and other information between the various parts of the computer 510. The processor 520 receives input data from the input device 526 and the network 514, reads and stores code and data in the storage device 522, and presents data to the output device 524.

Although the computer 510 is shown to contain only a single processor 520 and a single bus 530, the disclosed embodiment applies equally to computers that may have multiple processors, and to computers that may have multiple busses with some or all performing different functions in different ways.

The storage device 522 represents one or more mechanisms for storing data. For example, the storage device 522 may include read only memory (ROM), random access memory (RAM), magnetic disk storage media, optical storage media, flash memory devices, and/or other machine-readable media. In other embodiments, any appropriate type of storage device 522 may be used. Although only one storage device 522 is shown, multiple storage devices 522 and multiple types of storage devices 522 may be present. Further, although the computer 510 is drawn to contain the storage device 522, it may be distributed across other computers, for example on a server.

The storage device 522 includes a controller and data items 534. The controller includes instructions capable of being executed on the processor 520 to carry out the functions, as previously described above with reference to FIGS. 1-4. In another embodiment, the functions are carried out via hardware in lieu of a processor-based system. In one embodiment, the controller is a web browser, but in other embodiments, the controller may be a database system, a file system, an electronic mail system, a media manager, an image manager, or may include any other functions capable of accessing data items. Of course, the storage device 522 may also contain additional software and data (not shown), which is not necessary to understanding the invention.

Although the controller and the data items 534 are shown to be within the storage device 522 in the computer 510, they may be distributed across other systems, for example on a server and accessed via the network 514.

The output device 524 is that part of the computer 510 that displays output to the user. The output device 524 may be a liquid crystal display (LCD) well-known in the art of computer hardware. But, in other embodiments the output device 524 may be replaced with a gas or plasma-based flat-panel display or a traditional cathode-ray tube (CRT) display. In still other embodiments, any appropriate display device may be used. Although only one output device 524 is shown, in other embodiments any number of output devices of different types, or of the same type, may be present. In an embodiment, the output device 524 displays a user interface.

The input device 526 may be a keyboard, mouse or other pointing device, trackball, touchpad, touch screen, keypad, microphone, voice recognition device, or any other appropriate mechanism for the user to input data to the computer 510 and manipulate the user interface previously discussed. Although only one input device 526 is shown, in another embodiment any number and type of input devices may be present.

The network interface device 528 provides connectivity from the computer 510 to the network 514 through any suitable communications protocol. The network interface device 528 sends and receives data items from the network 514.

The bus 530 may represent one or more busses, e.g., USB (Universal Serial Bus), PCI, ISA (Industry Standard Architecture), X-Bus, EISA (Extended Industry Standard Architecture), or any other appropriate bus and/or bridge (also called a bus controller).

The computer 510 may be implemented using any suitable hardware and/or software, such as a personal computer or other electronic computing device. Portable computers, laptop or notebook computers, PDAs (Personal Digital Assistants), pocket computers, appliances, telephones, and mainframe computers are examples of other possible configurations of the computer 510. For example, other peripheral devices such as audio adapters or chip programming devices, such as EPROM (Erasable Programmable Read-Only Memory) programming devices may be used in addition to, or in place of, the hardware already depicted.

The network 514 may be any suitable network and may support any appropriate protocol suitable for communication to the computer 510. In an embodiment, the network 514 may support wireless communications. In another embodiment, the network 514 may support hard-wired communications, such as a telephone line or cable. In another embodiment, the network 514 may support the Ethernet IEEE (Institute of Electrical and Electronics Engineers) 802.3x specification. In another embodiment, the network 514 may be the Internet and may support IP (Internet Protocol). In another embodiment, the network 514 may be a local area network (LAN) or a wide area network (WAN). In another embodiment, the network 514 may be a hotspot service provider network. In another embodiment, the network 514 may be an intranet. In another embodiment, the network 514 may be a GPRS (General Packet Radio Service) network. In another embodiment, the network 514 may be any appropriate cellular data network or cell-based radio network technology. In another embodiment, the network 514 may be an IEEE 802.11 wireless network. In still another embodiment, the network 514 may be any suitable network or combination of networks. Although one network 514 is shown, in other embodiments any number of networks (of the same or different types) may be present.

The embodiments described herein may be implemented in an operating environment comprising software installed on any programmable device, in hardware, or in a combination of software and hardware.

Although embodiments have been described with reference to specific example embodiments, it will be evident that various modifications and changes may be made to these embodiments without departing from the broader spirit and scope of the invention. Accordingly, the specification and drawings are to be regarded in an illustrative rather then a restrictive sense.

1. Apparatus to process a plurality of wireless communications signals, the apparatus comprising:
a plurality of wireless receivers, each of the plurality of wireless receivers to concurrently receive wireless communications signals on a plurality of unique communications channels; and
a discriminator/analyzer module to identify data items being transmitted over each of the unique communications channels and analyze the identified data items.

2. The apparatus of claim 1, wherein the wireless communications signals are 802.11 communications signals.

3. The apparatus of claim 2, wherein the plurality of wireless receivers includes a wireless receiver for each of the channels allowable under the 802.11 standard.

4. The apparatus of claim 1, wherein the wireless communications signals are 802.16 communications signals.

5. The apparatus of claim 1, wherein the unique communications signals are transmitted over adjacent unique communications channels as defined in an applicable wireless band plan.

6. A system to receive and process a plurality of wireless communications signals, the system comprising:
a plurality of wireless receivers, each of the plurality of wireless receivers to receive one of the plurality of wireless communications signals;
a discriminator/analyzer module coupled to the plurality of wireless receivers to identify data items being transmitted over each of the plurality of wireless communications signals;
a storage device having instructions contained therein to analyze the data items;
a processor to execute the instructions; and
a bus to couple the discriminator module to the storage device and processor.

7. The system of claim 6, wherein the discriminator/analyzer module is a FPGA, the FPGA having instructions contained therein to digital down convert the intermediate frequency (IF) signal and then apply the proper Digital Signal Processing algorithms to recover the original digital data stream.

8. The system of claim 6, wherein the discriminator/analyzer module is an ASIC, the ASIC having instructions contained therein to digital down convert the intermediate frequency (IF) signal and then apply the proper Digital Signal Processing algorithms to recover the original digital data stream.

9. The system of claim 6, wherein the discriminator/analyzer module is a XiLinx FX12 FPGA.

10. The system of claim 6, wherein the bus is a USB bus.

11. The system of claim 10, wherein the plurality of wireless receivers and the discriminator module are contained in a device that is removeably attached to the USB bus.

12. The system of claim 6, wherein each of the wireless receivers is to concurrently receive wireless communications on adjacent unique channels, the adjacent unique channels operating at frequencies as defined in an applicable wireless band plan.

13. Method of processing a plurality of wireless communications signals, the method comprising:
receiving a plurality of wireless communications signals;
identifying unique communications channels; and
discriminating between the unique communications channels and separating the signals into unique communications streams.

14. The method of claim 13, further comprising
analyzing the unique communications streams.

15. The method of claim 13 wherein the plurality of wireless communications signals include a plurality of 802.11 signals.

16. A machine-readable medium having machine-executable instructions contained therein, which when executed perform the following operations:
receiving a plurality of wireless communications signals, each of the plurality of wireless communications signals received by a unique wireless receiver;
identifying unique communications channels; and
discriminating between the unique communications channels and separating the signals into unique streams.

17. The machine-readable medium of claim 16, further comprising:
analyzing the unique communications streams.

18. The machine-readable medium of claim 16, wherein each of the unique wireless receivers is to concurrently receive wireless communications signals.

19. The machine-readable medium of claim 18, wherein the wireless communications signals are transmitted on adjacent wireless communications channels.

20. The machine-readable medium of claim 19, wherein the wireless communications channels include at least two communications channels as defined by an applicable wireless band plan.
